(19) United States
(12) Patent Application Publication
(10) Pub. No.: US 2016/0088820 A1
(43) Pub. Date: Mar. 31, 2016

(54) Clam Digging Multi-Tool System

(71) Applicants: Robert Blankenship, Woodland, WA (US); Chad Blankenship, La Center, WA (US)

(72) Inventors: Robert Blankenship, Woodland, WA (US); Chad Blankenship, La Center, WA (US)

(21) Appl. No.: 14/864,738

(22) Filed: Sep. 24, 2015

Related U.S. Application Data
(60) Provisional application No. 62/057,789, filed on Sep. 30, 2014.

(51) Int. Cl. A01K 80/00

(52) U.S. Cl. CPC A01K 80/00

(57) ABSTRACT

A system for clam digging comprising a clam gun and a cart. The cart comprising a set of wheels, a tower, a plate, a lever, and a tether. The lever with a handle and an attachment point at opposite ends and a pivot mechanism in-between the opposite ends, the pivot mechanism coupled to an upper part of the tower. The tether with a first tether end and a second tether end, the first tether end configured for detachably coupling to the attachment point of the lever, wherein the second tether end has a vent hole cover configured for detachably coupling with the tubular handle of the clam gun and covering a vent hole in the tubular handle.

### CROSS-REFERENCE TO RELATED APPLICATION

This application claims the benefit of U.S. Provisional Application No. 62057789, filed Sep. 30, 2014, incorporated herein by reference.

### FIELD OF THE INVENTION

The present invention relates to the field of shell fish digging tools and systems.

### BACKGROUND

Since hunter-gather days, humans have dug in beach sand for shellfish such as clams. Clams can be dug out of the sand at low tide, but the digger must be stealthy or quick as clams can dig and move away through the sand with astonishing speed. Specialized tools have developed to assist diggers with speed and stealth. One of the most popular is a “clam gun.” The clam gun is a hollow tube, usually cylindrical in shape, open at a bottom end, and closed at a top end, but with a vent hole in the top end. The clam gun also typically has a handle, usually t-shaped on the top end. One places the open end of the clam gun over the “show” in the sand of the beach. The “show” is a small hole in the sand that indicates a clam is below. The user pushes down on the handle to push the hollow tube into the sand of the beach, twisting and/or rocking as necessary. Once the hollow tube has penetrated the sand to a sufficient depth, the user then plugs the vent hole, usually with a thumb or finger, and pulls the hollow tube up out of the sand with the handle. The entire column of sand, hopefully containing a clam, is removed from the beach. The user then uncovers the vent hole and empties the sand from the hollow tube onto the surface of the beach. The user then breaks up the column of sand and recovers any clams that were pulled out along with it.

A clam gun, as useful as it is, can be heavy and cumbersome to carry on the beach. Pulling the clam gun out of the sand with the vent hole covered requires significant back strength. Users with back problems can find it too painful to use a clam gun. What is needed is a device that is as effective as a clam gun, but is easier to transport and is easier on a user's back.

### SUMMARY

The clam digging multi-tool system described herein is designed to aid the outdoorsman, shell fish digger(s) to be able to lessen the strain of the sport for digging clams. This design uses mechanical advantage when pulling up the clam gun (aka claim tool). It is easily attached and released from the clam gun when needed. The multi-tool device also incorporates a light for assisting the user(s), It also acts as a wheeled carrier to and from the digging site again lessening the strain for the user(s). It will also be used for the storage of the clam gun while the user is in search of the clams. This system is meant either to be carried or pulled. The light weight design is to help with eliminating muscle fatigue during the operation of pulling the clam gun out of the earth surface. The clam digging system is adjustable per the user's height and strength.

### BRIEF DESCRIPTION OF THE DRAWINGS

The present invention will be described by way of exemplary embodiments, but not limitations, illustrated in the accompanying drawings in which like references denote similar elements, and in which:

The accompanying drawings, which are incorporated into and constitute a part of this specification, illustrate one or more embodiments of the invention and, together with the detailed description, serve to explain the principles and implementations of the invention.

FIG. 1 shows a clam digging multi-tool system in a stationary configuration.

FIG. 2 shows the clam digging system in a traveling configuration.

FIG. 3 shows the clam digging system in a clam digging configuration, with the clam gun in a lowered position.

FIG. 4 shows the clam digging system in the clam digging configuration, with the clam gun in a raised position.

FIG. 5 shows a tether of the clam digging system on the tubular handle of a clam gun, with a vent hole cover attached to the tether, pulled aside to show the vent hole leading to the interior cavity of the clam gun.

FIG. 6 shows the tether of the clam digging system on the tubular handle of a clam gun, with a vent hole cover attached to the tether and positioned to cover the vent hole.

FIG. 7 shows the retention post on the plate of the cart of the clam digging system.

### DETAILED DESCRIPTION

Before beginning a detailed description of the subject invention, mention of the following is in order. When appropriate, like reference materials and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Use of directional terms such as “upper,” “lower,” “above,” “below”, “in front of,” “behind,” etc. are intended to describe the positions and/or orientations of various components of the invention relative to one another as shown in the various Figures and are not intended to impose limitations on any position and/or orientation of any embodiment of the invention relative to any reference point external to the reference.

Those skilled in the art will recognize that numerous modifications and changes may be made to the exemplary embodiment(s) without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the exemplary embodiment(s) is essential. Other embodiments are possible, their specific designs depending upon the particular application. As such, the scope of the invention should not be limited by the particular embodiments herein described but should be defined only by the appended claims and equivalents thereof

### Exemplary Embodiment—Structure

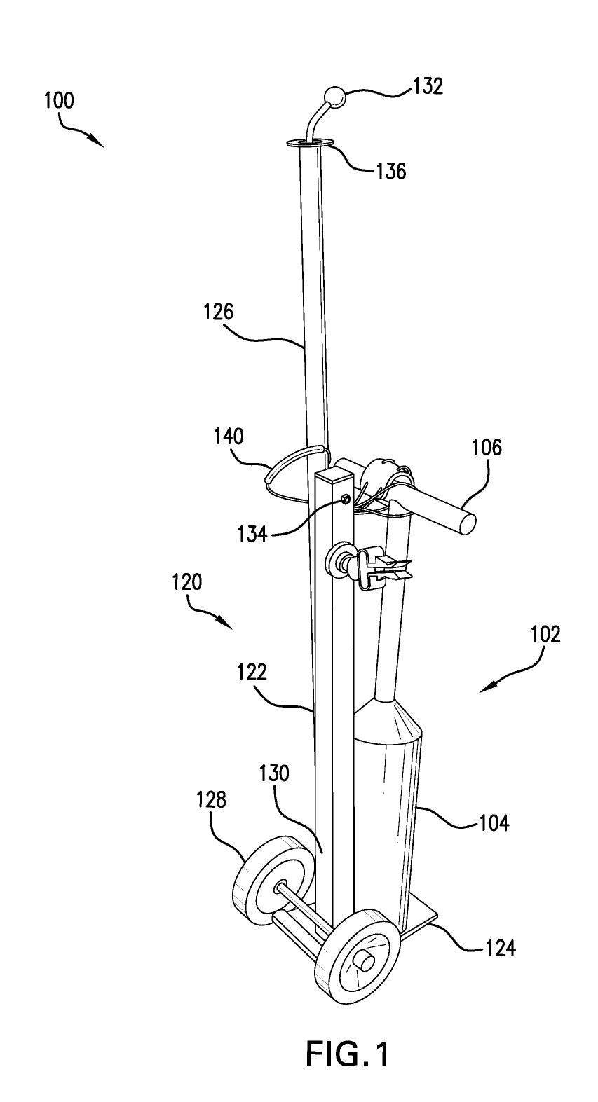

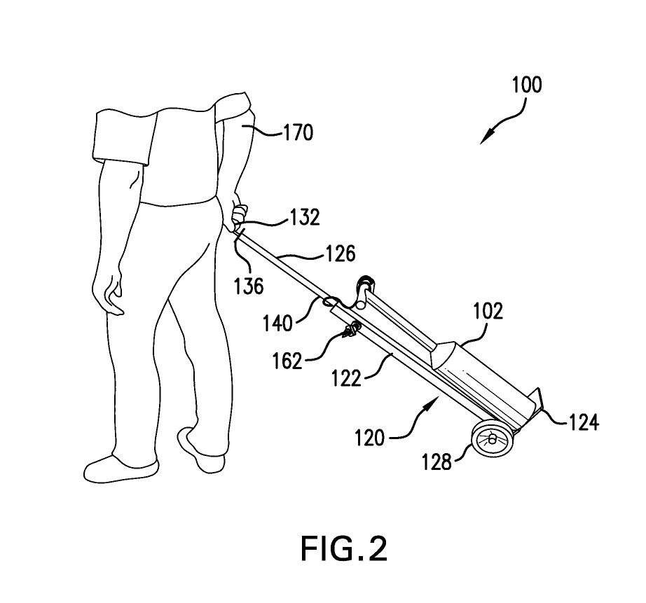

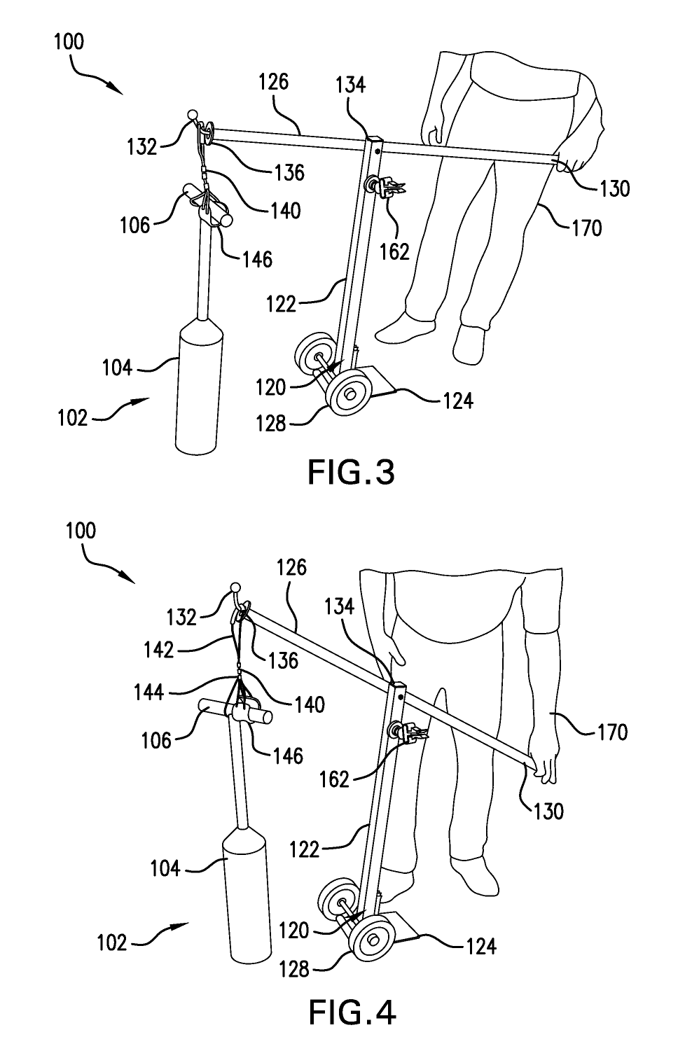

FIGS. 1-7 show an exemplary embodiment of a clam digging system 100. The clam digging system 100 comprises a clam gun 102 and a cart 120. The cart 120 has a tether 140 which is used to couple the cart 120 with the clam gun 102. In the exemplary embodiment, the tether 140 is configured to detachably couple to both the cart 120 and the clam gun 102, but in other embodiments, the tether 140 may be attached more permanently to either the cart 120 or to the clam gun 102 or to both. The clam digging system 100 is configured to allow a user 170 to place it in a stationary configuration (see FIG. 1), a traveling configuration (see FIG. 2), and in a clam digging configuration (see FIGS. 3 and 4).

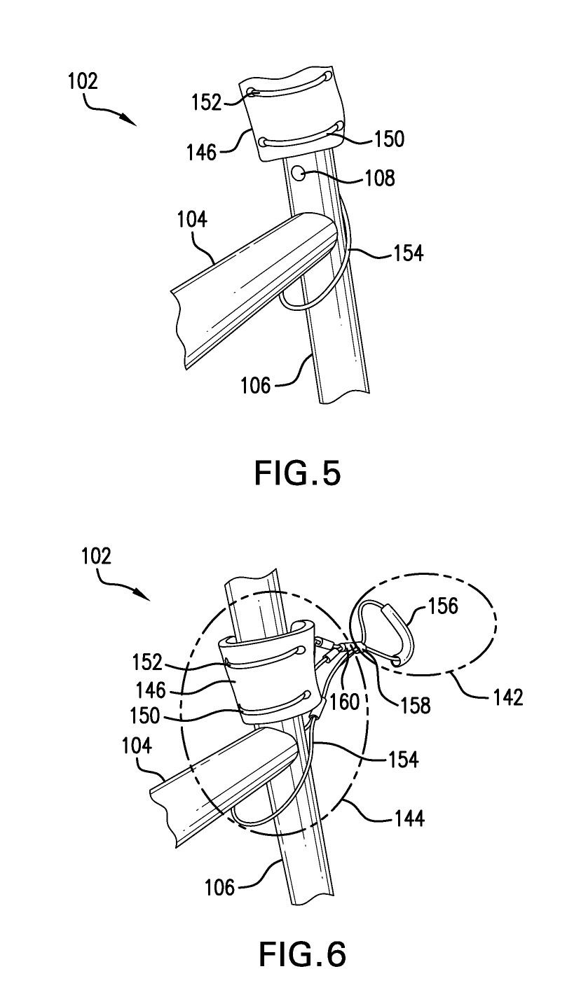

The clam gun 102 comprises a tubular housing 104 and a tubular handle 106 attached to an upper portion of the tubular housing 104. The clam gun 102 has an interior cavity defined by the tubular housing 104 and tubular handle 106. The tubular handle 106 has a vent hole 108 (see FIG. 5) configured for allowing air flow between the interior cavity and an exterior environment. In the exemplary embodiment, the vent hole 108 is on the bottom of the tubular handle 106 near to the tubular housing 104, but in other embodiments may be on a side of the tubular handle 106 and further away from the tubular housing 104. The clam gun 102 may be made of metal, PVC or other suitable material.

The cart 120 comprises a tower 122, a plate 124, a lever 126, a flashlight holder 162, and a set of wheels 128. In the exemplary embodiment, the tower 122 is a simple post comprising a tube of metal, but in other embodiments may be made of other suitable materials and may have a more elaborate structure that more resembles a frame or lattice pylon. The tower 122 in the exemplary embodiment is about 3 feet high, which is about waist height for the average user. This height is low enough to allow the user 170 to push down on the lever 126 using their weight rather than just muscle strength, but high enough to give sufficient room for pivoting for a lever 126 sufficiently long enough to give good mechanical advantage and range of motion to lift the clam gun 102. However, in other embodiments, the tower 122 may have a different height.

The wheels 128 are coupled to a lower end of the tower 122, typically by welding. The wheels 128 provide mobility for the clam digging system 100 when in the traveling configuration. The plate 124 is coupled to the bottom of the tower 122, typically by welding. The plate 124 provides stability for the clam digging system 100 when in stationary configuration (see FIG. 1) or clam digging configuration (see FIGS. 3 and 4). The plate 124 extends orthogonally rearward from beneath an axle of the set of wheels 128, that is, away from the direction the clam digging system 100 would be pulled when in traveling configuration and away from the side where the clam gun 102 would be deployed when in the clam digging configuration. In the exemplary embodiment, the plate 124 is no wider than the distance between the wheels 128, but in other embodiments, the plate 124 may be wider rearward of the wheels 128 for extra lateral stability. The plate 124 is configured so that when in the clam digging configuration, the downward forces applied by the user 170 on the lever 126 are transmitted through the tower 122 and through the plate 124 to the ground. The plate 124, tower 122 and wheels 128 are coupled together and configured in such a manner so that the tower 122 can be tilted forward and the plate 124 will rotate back and up away from contact with the ground, leaving only the wheels 128 in contact with the ground.

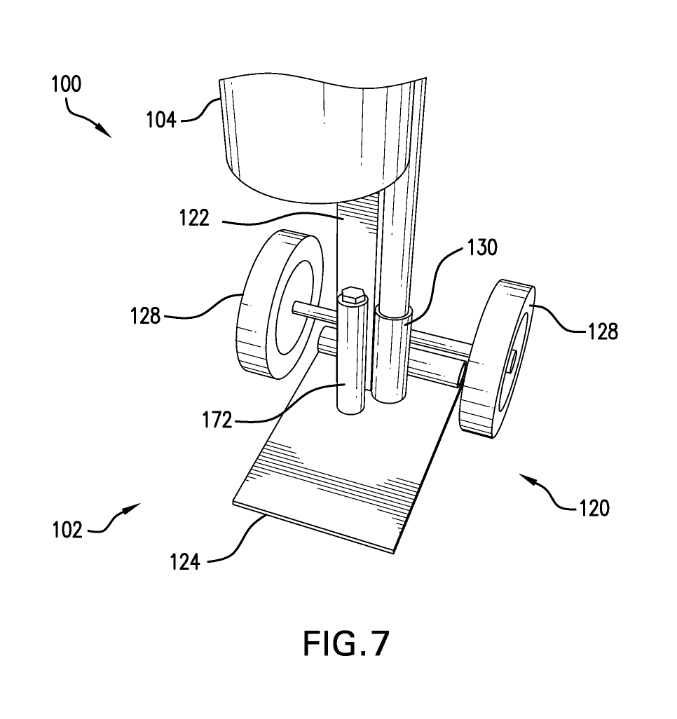

The plate 124 has a retention post 172 (see FIG. 7) coupled, typically by welding, on an upper side of the plate 124 near the tower 122, with a gap between the retention post 172 and the tower 122. The retention post 172 secures the clam gun 102 to the cart 120 when the clam digging system 100 is in stationary configuration or traveling configuration, with the retention post 172 inside the tubular housing 104 and a wall of the tubular housing 104 held in the gap between the retention post 172 and the tower 122.

The lever 126 has a handle 130 and an attachment point 132 at opposite ends. In the exemplary embodiment, the lever 126 is a metal tube, but in other embodiments, it may be solid or be made of other suitable materials. The lever 126 has a pivot mechanism 134 in-between the opposite ends. The pivot mechanism 134 couples the lever 126 to an upper part of the tower 122. In the exemplary embodiment, the pivot mechanism 134 is a simple threaded screw passing through similarly sized holes in the lever 126 and tower 122. However, in other embodiments, different mechanisms may be used for the pivot mechanism 134, such as an oar-lock bracket through which the lever 126 slidingly passes, allowing the mechanical advantage of the lever 126 to be changed and permitting a longer lever 126 to be used. With a more fixed pivot mechanism 134, the lever 126 from the pivot mechanism 134 to the end of the handle 130 can be no longer than the height of the tower 122 from the plate 124 to the pivot mechanism 134 and still be able to stow for the traveling configuration. In some embodiments, the pivot mechanism 134 is height-adjustable, allowing the user 170 to move the pivot mechanism 134 higher or lower on the tower 122. A user 170 of shorter stature may find a lower position for the pivot mechanism 134 will give better leverage. The height-adjustable feature may be accomplished by additional holes in the tower 122 or by some other mechanism.

The attachment point 132 in the exemplary embodiment is a hook with a rounded end for safety. In other embodiments, the attachment point 132 may be some other mechanism for attaching the tether 140 more permanently, such as a tie-down ring to which the tether 140 may be crimped, or the attachment point 132 may be some other mechanism for detachably coupling the tether 140, such as an anchored carabineer.

The tether 140 has a first tether end 142 and a second tether end 144. The first tether end 142 is configured for coupling with the attachment point 132 and the second tether end 144 is configured for coupling with the tubular handle 106 of the clam gun 102. In the exemplary embodiment, the first tether end is configured for detachably coupling to the attachment point 132 of the lever 126, but in other embodiments may be more permanently fixed to the attachment point 132. The second tether end 144 has a vent hole cover 146 that is configured for detachably coupling with the tubular handle 106 of the clam gun 102 and covering the vent hole 108 in the tubular handle 106 (see FIGS. 5 and 6).

In the exemplary embodiment, the second tether end 144 comprises a first loop 150, a second loop 152, and a third loop 154 while the first tether end 142 comprises a fourth loop 156. However, in other embodiments, the tether 140 may have different structures. The fourth loop 156 is configured to couple with the attachment point 132, which in the exemplary embodiment is a hook. The fourth loop 156 couples with the attachment point 132 by passing the fourth loop 156 over the hook and is held in place by tension applied by the user 170 pushing down on the handle 130 of the lever 126. In the exemplary embodiment, the lever 126 has a retention disk 136 at the end near the attachment point 132. When the tether 140 is coupled to the attachment point 132 hook and tension is being applied to the tether 140 by the lever 126, the retention disk 136 blocks the tether 140 from slipping further down the lever 126 towards the pivot mechanism 134. The fourth loop 156 is large enough so that when it is not under tension, the user 170 can slip the fourth loop 156 over the retention disk 136 and down towards the pivot mechanism 134 for the purpose of putting the clam digging system 100 in traveling configuration.

The first loop 150 and the second loop 152 are coupled to the vent hole cover 146. In the exemplary embodiment, the vent hole cover 146 is a square of rubber with four holes, but in other embodiments may have different structures. The four holes are used to couple the vent hole cover 146 to the first loop 150 and second loop 152. The first loop 150 passes through two of the four holes and the second loop 152 passes through the other two. The second tether end 144 is configured for coupling to the tubular handle 106 by passing the first loop 150 and second loop 152 over one end of the tubular handle 106 and then passing the third loop 154 over another end of the tubular handle 106. The user 170 should ensure that the first loop 150 and second loop 152, which are coupled to the vent hole cover 146, are passed over the end of the tubular handle 106 that has the vent hole 108.

In the exemplary embodiment, the tether 140 further comprises a first node 158 and a second node 160. The first loop 150 and the second loop 152 are coupled to the first node 158. The first node 158 is coupled to the second node 160, as are the third loop 154, and the fourth loop 156. The first loop 150 and the second loop 152 are of equal length to facilitate substantially equal load sharing between when tension is applied to the second node 160. Likewise, the assembly of the first loop 150, the second loop 152 and the second node 160 is of equal length with the third loop 154 to facilitate substantially equal load sharing between when tension is applied to the first node 158. Tension is applied to the first node 158 via the fourth loop 156 when the fourth loop 156 is coupled to the attachment point 132 hook and the user 170 applies force downwards on the handle 130 of the lever 126.

### Exemplary Embodiment—Operation

FIG. 1 shows a clam digging system 100 in the stationary configuration. This is the configuration the clam digging system 100 will typically be in when not in use. This configuration is compact and stable for storage. The clam gun 102 rests on the plate 124 of the cart 120, held in place by gravity. The retention post 172 (see FIG. 7) is inserted into the interior cavity of the clam gun 102 and impedes the clam gun 102 from moving laterally off of the plate 124. The lever 126 is rotated into a vertical orientation with the attachment point 132 high and the handle 130 low, adjacent to the plate 124. In some embodiments, the handle 130 end may be weighted slightly to facilitate the lever 126 naturally rotating into this position when not in use. In some embodiments, the lever 126 from the pivot mechanism 134 to the handle 130 may be longer than the lever 126 from the pivot mechanism 134 to the attachment point 132, which will accomplish this same effect and give greater mechanical advantage as well. The tether 140 has been slipped past the retention disk 136 and has slid down the lever 126 towards the pivot mechanism 134. This keeps the tether 140 secure and out of the way.

FIG. 2 shows the clam digging system 100 in the traveling configuration. The user 170 has taken hold of the lever 126 at the attachment point 132 and pulled it forward while pushing the tower 122 forward. This has caused the cart 120 to rotate around the axle of the wheels 128, rotating the plate 124 out of contact with the ground. Once significantly rotated (˜45 degrees) the weight of the cart 120 will tend to keep the cart 120 in this position, even if the user 170 is only holding on to the attachment point 132. In some embodiments, the lower portion of the lever 126 towards the handle 130 is held against the tower 122 by a clip or some other fastening mechanism. In traveling configuration, the user 170 can easily transport the clam digging system 100 across a beach to the desired clam digging location.

FIG. 3 shows the clam digging system 100 in the clam digging configuration, with the clam gun 102 in a lowered position. The cart 120 is oriented with the tower 122 vertical and the plate 124 in contact with the ground, providing good stability. In transitioning from the stationary configuration, the user 170 lifts the clam gun 102 up off the plate 124 until the bottom of the tubular housing 104 clears the retention post 172 (see FIG. 7). The user 170 may then move the clam gun 102 into position for digging. When moving the clam gun 102 into position the tether 140 slides along the lever 126 towards the attachment point 132. Alternatively, the user 170 can decouple the tether 140 from either the clam gun 102 or the cart 120 while moving the clam gun 102 and/or while digging, recoupling the tether 140 when the user 170 has dug the clam gun 102 into the desired depth. The user 170 may place a flashlight in the flashlight holder 162 to illuminate the digging area.

FIG. 4 shows the clam digging system 100 in the clam digging configuration, with the clam gun 102 in a raised position. With the tether 140 secured to the attachment point 132 and to the clam gun 102, the vent hole cover 146 properly positioned over the vent hole 108, the user 170 pushes down on the handle 130 of the lever 126, causing the lever 126 to put tension on the tether 140, which pulls the clam gun 102 up out of the ground (sand). To give additional stability, the user 170 may step on the plate 124 while pulling out the clam gun 102. The user 170 may then ease off the downward force on the handle 130 to set the clam gun 102 down on the beach beside the hole it just dug. The clam gun 102 will be swinging, so the user 170 can easily time the lowering of the clam gun 102 to miss the hole. The user 170 then moves the vent hole cover 146 aside from the vent hole 108. The user 170 may then use the lever 126 to again raise the clam gun 102 to empty the contents of the clam gun 102 onto the surface of the beach. Alternatively, the user 170 may grasp the tubular handle 106 of the clam gun 102 directly, first removing the tether 140 if desired, then lifting the clam gun 102 to empty its contents.

What is claimed is:

1. A system for clam digging comprising:
a clam gun comprising a tubular housing, and a tubular handle attached to an upper portion of the tubular housing, the clam gun having an interior cavity defined by the tubular housing and tubular handle, the tubular handle having a vent hole configured for allowing air flow between the interior cavity and an exterior environment;
a cart comprising a tower, a plate, a lever, and a set of wheels, wherein the lever has a handle and an attachment point at opposite ends, wherein the lever has a pivot mechanism in-between the opposite ends, the pivot mechanism coupled to an upper part of the tower; and
a tether with a first tether end and a second tether end, the first tether end configured for detachably coupling to the attachment point of the lever, wherein the second tether end has a vent hole cover configured for detachably coupling with the tubular handle of the clam gun and covering the vent hole in the tubular handle.

2. The system of claim 1, wherein the set of wheels is coupled to a lower part of the tower; and
wherein the plate is coupled to the lower part of the tower and extending orthogonally from the tower.

3. The system of claim 2, further comprising a retention post coupled to an upper side of the plate.

4. The system of claim 2, further comprising:
wherein the cart is configured to be in a stationary configuration and a traveling configuration;
wherein the tower is substantially vertical in the stationary configuration and substantially non-vertical in the traveling configuration;
wherein the plate, the set of wheels and the tower are configured such that the plate is in contact with the ground when the cart is in the stationary configuration; and
wherein the plate, the set of wheels and the tower are configured such that the plate is not in contact with the ground the cart is in the traveling configuration.

5. The system of claim 1, wherein the second tether end comprises a first loop, a second loop, and a third loop; and
wherein the vent hole cover is coupled to the first loop and the second loop.

6. The system of claim 5,
wherein the first tether end comprises a fourth loop;
wherein the tether further comprises a first node and a second node;
wherein the first loop and the second loop are coupled to the first node; and
wherein the first node, the third loop, and the fourth loop are coupled to the second node.

7. The system of claim 6, wherein the attachment point is a hook configured for engaging the fourth loop.

8. A device comprising:
a tower;
a lever with a handle and an attachment point at opposite ends, the lever with a pivot mechanism in-between the opposite ends, the pivot mechanism coupled to an upper part of the tower; and
a tether with a first tether end and a second tether end, the first tether end coupled to an upper part of the lever, wherein the second tether end has a vent hole cover configured for wrapping around a tubular handle of a clam gun and covering a vent hole in the tubular handle.

9. The device of claim 8, further comprising:
a set of wheels coupled to a lower part of the tower; and
a plate coupled to the lower part of the tower and extending forward of the tower.

10. The device of claim 9, further comprising
a retention post coupled to an upper side of the plate.

11. The device of claim 9, further comprising:
wherein the device is configured to be in a stationary configuration and a traveling configuration;
wherein the tower is substantially vertical in the stationary configuration and substantially non-vertical in the traveling configuration;
wherein the plate, the set of wheels and the tower are configured such that the plate is in contact with the ground when the device is in the stationary configuration; and
wherein the plate, the set of wheels and the tower are configured such that the plate is not in contact with the ground the device is in the traveling configuration.

12. The device of claim 8,
wherein the second tether end comprises a first loop, a second loop, and a third loop; and
wherein the vent hole cover is coupled to the first loop and the second loop.

13. The device of claim 12,
wherein the first tether end comprises a fourth loop;
wherein the tether further comprises a first node and a second node;
wherein the first loop and the second loop are coupled to the first node; and
wherein the first node, the third loop, and the fourth loop are coupled to the second node.

14. The device of claim 13,
wherein the attachment point is a hook configured for engaging the fourth loop.
